(19) United States
(12) Patent Application Publication
(10) Pub. No.: US 2022/0371948 A1
(43) Pub. Date: Nov. 24, 2022

(54) CARRIER FOR POWDER MATERIALS

(71) Applicant: Potters Industries, LLC, Wilmington, DE (US)

(72) Inventor: Gonçalo Alexandre Rosa Grilo, Saint-Pourcain sur Sioule (FR)

(21) Appl. No.: 17/741,516

(22) Filed: May 11, 2022

Related U.S. Application Data
(60) Provisional application No. 63/189,892, filed on May 18, 2021.

(51) Int. Cl. C03C 17/30; C03C 17/22

(52) U.S. Cl. CPC C03C 17/30; C03C 17/22; C03C 2214/05

(57) ABSTRACT

A carrier for delivering powder materials includes a microsphere, such as a glass microbead, bead and a coating provided on the glass microbead. If the powder material is an inorganic powder, the coating is preferably a dipodal polysiloxane. If the powder material is an organic powder, the coating is preferably vinyl polysiloxane. The microsphere carrier provides a controlled distribution of the powder material for industrial and other applications.

### FIELD OF THE INVENTION

The present invention relates to carriers for powder materials and more particularly to carriers such as solid glass microspheres and coatings selected for their affinity to both glass microspheres and powders.

### BACKGROUND OF THE INVENTION

Precise delivery of powder materials is an ongoing challenge in certain industrial and medical applications. If the powder is in pellet form, the core of the pellet is often used in the application and becomes excess material. Depending on the cost of the powder, this unused core material can add substantial cost to the application.

Alternatively, the powder material can be applied to a carrier. However, the powder material will not generally adhere well to the surface of the carrier resulting in excess dust of the powder falling off the carrier before being used. This as well adds cost to the application to account for the lost powder dust and may also result in environmental control issues depending on the nature of the dust.

There is a need for a better delivery mechanism for precise delivery of powder materials.

### SUMMARY OF THE INVENTION

It has been found that solid glass microspheres can also be used as carrier vehicles for delivering powder material. Glass microspheres having a specific coating have been found to be an effective carrier for solid substances, allowing an improved dosage rate linked to glass microsphere specific surface, without any secondary reaction.

In a preferred embodiment, a carrier for delivering powder materials includes a glass microsphere and a coating provided on the glass microsphere. If the powder material is an inorganic powder, the coating is preferably a dipodal polysiloxane. If the powder material is an organic powder, the coating is preferably vinyl polysiloxane.

Suitable dipodal polysiloxanes include CoatOSil FLX, SI69 and Dynasylan 1124.

Suitable vinyl polysiloxanes include Silquest G-170.

The carriers of the present invention can be used for multiple applications including precise delivery of catalysts and other chemicals for industrial applications and the delivery of radioactive, or UV reactive, but not only, tracers for medical applications but not only.

The present invention provides advantages over existing powder delivery systems. A generally constant quantity of powder can be delivered when the powder is carried on the surface of a glass microsphere. The present delivery system is easier to handle and to dosage due to the free-flowing characteristic of glass microspheres. The present system does not require admixtures as the powder adheres directly over the glass microsphere surface. Because the present system uses a limited amount of powder which is securely adhered to the glass microsphere, there is a limited amount of free dust produced.

The present system increases product homogeneity, creates a constant delivered rate of powder based on the glass microspheres' specific surface, and is easier to handle and to dosage due to spherical characteristics of glass microsphere carrier.

### BRIEF DESCRIPTIONOF THE DRAWINGS

FIG. 1 is an optical microscope image of a glass sphere with GB-50X benzoyl peroxide.

FIG. 2 is an SEM image of a section of the surface of the glass sphere of FIG. 1.

PREFERRED FORM OF EMBODIMENT OF THE INVENTION

Although the present invention is described with reference to preferred embodiments, it will be understood by those skilled in the art that several changes can be made and the equivalents can be replaced by elements thereof

It has been found that glass microspheres are an excellent carrier for solid particles such as powdered metals. A specific coating applied over the glass microspheres selected based on the nature of the solid particles allows the solid particles to be affixed to the glass microspheres, creating a shield of solid particles around a glass microsphere core. The solid particles can be precisely metered on the glass microspheres. The amount of the solid powder to be delivered can be precisely controlled by selecting the size and surface area of the glass microspheres to which the solid powders are affixed.

Preferably, the glass microspheres should have a particle size distribution between 10 μm and 2360 μm for most applications. Preferably, glass microspheres smaller than 20 μm are not be used nor are glass microspheres larger than 2000 μm.

A presently preferred coating for inorganic particles is a dipodal polysiloxane coating such as CoatOSil FLX, which is applied over the glass microspheres surface, in an amount consistent with the specific surface coverage calculation for the size of the glass microsphere. The inorganic particles will adhere to the dipodal polysiloxane coating, thereby securing the inorganic particle to the glass microsphere surface. Other suitable coatings include S169 and Dynasylan 1124.

A presently preferred coating for organic particles is vinyl polysiloxane. Suitable vinyl polysiloxanes include Silquest G-170.

It has been found that water-based or alcohol-based coatings should preferably be avoided, because they may generate secondary reactions with the powdered material.

One example of precise delivery of a powdered material is the use of glass microspheres as a carrier for holmium oxide which is used in radiotherapy applications. A dipodal silane coating applied over the glass microspheres secures the solid oxide particles to the microspheres, creating a layer of solid particles around the glass microsphere core.

The present invention is particularly suitable where the powder material to be delivered is relatively expensive and there is a concern about wasting excess powder in the delivery process. By affixing the desired quantity of powder to the microspheres, there is less waste as the powder will not readily be released from the coating in transport. Moreover, because the powder is isolated on the surface and not the interior of the microsphere, more efficient utilization of the powder material occurs in industrial applications.

The powder material can be affixed to the microspheres by first coating the microspheres and then adding the powder material to be attached to the coated microsphere surface. Alternatively, the microspheres can be mixed with the powder material and then the coating can be added which will adhere to the microsphere surface and to the powder material, affixing the powder material to the surface of the microsphere.

### EXAMPLES

Solid glass microspheres having a diameter of 250-850 microns were used as the carrier vehicle in a series of tests. These glass spheres were mixed with benzoyl peroxide and silane.

In a first test, these components were mixed in the following order: 1000 grams of glass microspheres, 14 grams of GB-50X benzoyl peroxide, and 4 molecular layers of G-170 silane. The resulting product was not dusty and some GB-50X benzoyl peroxide agglomerations were observed. Using the internal titration method PRC992B, 14 grams of peroxide per kilogram of glass beads were detected.

A second test was conducted on a larger industrial scale. In this test, the components were added in the following order: 50 kg of glass spheres, 7 grams of GB-50 X benzoyl peroxide, and 4 molecular layers of G-170 silane as calculated based on the glass microspheres' specific surface. The resulting product was not dusty and no peroxide agglomerations were observed. Using the titration method PRC992B, 2.4 grams of benzoyl peroxide per kilogram of glass microspheres were observed. This equates to 34% of the initial amount of benzoyl peroxide.

A third test was conducted, also on a larger industrial scale. In this test, the components were added in the following order: 100 kg of glass spheres, 14 grams of GB-50X benzoyl peroxide, and 4 molecular layers of G-170 silane as calculated based on the glass microspheres' specific surface. The resulting product was not dusty and no peroxide agglomerations were observed. Samples from several locations in the production process were taken for further analysis. Using the titration method PRC992B, 5.35 grams of benzoyl peroxide per kilogram of glass microspheres were observed. This equates to 38% of the initial amount of benzoyl peroxide.

Table 1 below shows the distribution of benzoyl peroxide and shows how much is affixed to the microsphere surface:

TABLE 1

| Harvesting place | Distribution of real benzoyl peroxide at different process steps |
|---|---|
| Waste from sieving | 35.5 g/kg |
| Chemical vessel bottom | 28.3 g/kg |
| Glass microspheres | 5.35 g/kg |

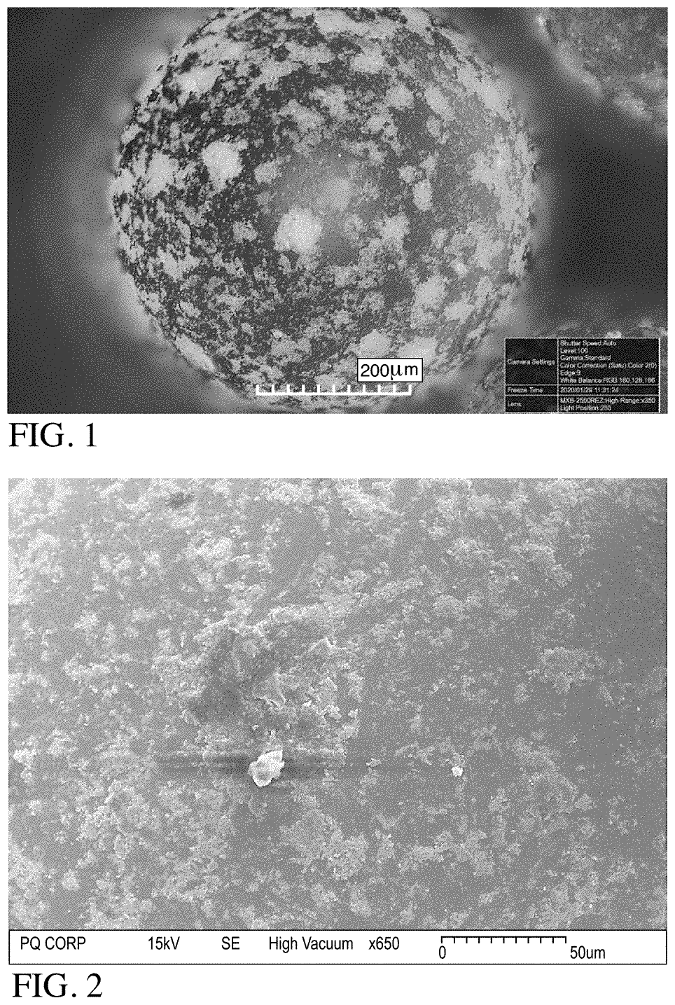

The benzoyl peroxide is distributed generally homogenously around the surface of the glass microsphere. FIG. 1 is an optical microscope image of a glass microsphere showing clusters of the GB-50X peroxide affixed thereto. FIG. 2 is an SEM image of a section of the surface of the glass microsphere. FIGS. 1 and 2 both show a cluster of peroxide on the glass microsphere surface.

A fourth test was conducted using a different mixing method. In this test, the components were added in the following order: 100 kg of glass microspheres, 15 molecular layer of the G-170 silane, to cover the glass microspheres specific surface, and 14 grams of GB-50X benzoyl peroxide. This process reversed the mixing order described in the prior tests. The quantity of silane G-170 was determined as a function of the glass microspheres specific surface and not as a function of benzoyl peroxide specific surface.

The resulting product was not dusty and no GB-50X peroxide agglomerations were observed. Samples from several locations were taken for further analysis. Using the titration method PRC992B, 6.54 grams of active peroxide per kilogram of glass spheres were detected. This equates to 47% of the initial amount, a higher quantity than the prior trials.

Table 2 below shows the distribution of benzoyl peroxide and shows how much is affixed to the microsphere:

TABLE 2

| Harvesting place | Distribution of real benzoyl peroxide at different process steps |
|---|---|
| Waste from sieving | 55.0 g/kg |
| Chemical vessels bottom | 24.7 g/kg |
| Glass microspheres | 6.54 g/kg |

Due to process of the particles' attachment to the glass beads surface, the benzoyl peroxide will be partially inactive and not detected in the titration method.

A fifth test was conducted using a lower mixer speed. In this test, the components were added in the following order: 100 kg of glass microspheres, 15 molecular layer of the G-170 silane to cover the glass microspheres specific surface, and 14 grams of GB-50X benzoyl peroxide. The glass microspheres were placed in the chemical vessel for 1 minute at 32 rpm. The silane G-170 was added under stirring for 1 minute; at this time, the glass microspheres should be well wet. GB-50X benzoyl peroxide is added and mixed for 4 minutes at a speed of 32 rpm. The results of this test showed that the lower mixing speed was insufficient to properly homogenize the resulting product.

A sixth test was conducted having a higher amount of the silane G-170. In this test, the components were added in the following order: 100 kg of glass microspheres, 20 molecular layer of the G-170 silane to cover the glass microspheres specific surface, and 14 grams of GB-50X benzoyl peroxide. The glass microspheres were placed in the chemical vessel for 1 minute at 32 rpm. The silane G-170 was added under stirring for 1 minute; at this time, the glass microspheres should be well wet. GB-50X benzoyl peroxide is added and mixed for 4 minutes at a speed of 32 rpm. The results of this test showed that the higher level of silane was not effective. The resulting product was not dry and the rate of peroxide attached to the glass microspheres was lower than with less silane.

A seventh test was conducted to determine the most efficient ratio silane and benzoyl peroxide to be applied. In this test, 100 kg of 600-125 micron-sized glass microspheres, varying amounts of the silane G-170, and varying amounts of benzoyl peroxide GB-50X were used. The glass microspheres were added to the chemical vessel and mixed for 1 minute at 32 rpm. Silane G-170 was the added, and the mixture was stirred for 1 minute, after which time all of the glass spheres should be well wet. Benzoyl peroxide GB-50X was then added and the contents were mixed for 4 minutes at a speed of 64 rpm. The amount of benzoyl peroxide attached to glass microspheres surface was then computed.

The results of this test are shown in Table 3 below:

TABLE 3

| Glass | | GB- | Peroxide | | |
|---|---|---|---|---|---|
| spheres | G-170 | 50X | rate | | |
| (kg) | (grams) | (grams) | (PRC992B) | Efficiency | Comments |
| 100 | 85 | 1800 | 7.93 g/kg | 44.1% | Wet product |
| 100 | 80 | 2600 | 9.77 g/kg | 37.6% | Almost dry |
| | | | | | product |
| 100 | 75 | 1400 | 7.74 g/kg | 55.3% | Wet product |
| 100 | 50 | 1400 | 6.26 g/kg | 44.7% | Virtually dry |
| | | | | | product |

The results of this test show that a balance between the levels of silane G-170 and benzoyl peroxide can be found that provides the best efficiency.

A tenth test was performed to assess the reactivity of coated glass beads. In this test, glass beads having a diameter of 250-850 microns were coated with benzoyl peroxide through the internal protocol PRC920B. A paint coat from Helios was used as the binder. The tests were conducted a room temperature of 17.5° C. and a relative humidity of 64.8%. Specifications for the resulting product require a curing time of less than 60 minutes, using a ratio 2:1 of paint to benzoyl peroxide. Times and reaction temperature between until full paint curing are presented in Table 4 below, showing that these samples met the drying time specifications.

TABLE 4

| Amount | Amount of glass | tᵢ (initial | t_{f} (final | |
|---|---|---|---|---|
| of paint | microspheres | temperature) | temperature) | Time |
| 202.3 g | 100.3 g | 16.2° C. | 62° C. | 30 min |
| 201.0 g | 200.0 g | 16.2° C. | 60° C. | 25 min |

Further trials were performed to optimize the delivery rate of benzoyl peroxide GB50X. Various glass microspheres using different glass microspheres particle distributions were evaluated with the object to deliver values of benzoyl peroxide GX50 on the glass microspheres surface of 8 g/kg±1.5 g/kg. Table 5 below shows the capability to link the delivery rate of benzoyl peroxide GB50X as a function of the glass microsphere surface. Optimizing the process provides a more stable content of benzoyl peroxide GX50 on glass microspheres surface around 8 g/kg.

TABLE 5

| | | | | | Content of benzoyl |
|---|---|---|---|---|---|
| | | | | | peroxide GX50 on |
| | | | Benzoyl | | glass |
| Tecno Beads\ | Glass | Silane | Peroxide | | microspheres |
| Raw materials | Spheres | G170 | GB50X | AntiSkid | surface |
| Echostar 5 BCP | 80% | 0.06% | 2.3% | ADS21 | 9.4 g/kg |
| TECNO SRT | | | | 20% | |
| (125-710 | | | | | |
| microns) | | | | | |
| Echostar 5 BCP | 100% | 0.075% | 3.5 % | | 7.3 g/kg |
| TECNO | | | | | |
| (125-710 | | | | | |
| microns) | | | | | |
| OV | 100% | 0.075% | 1.4% | | 6.5 g/kg |
| (250-850 | | | | | |
| microns) | | | | | |
| Echostar 30 | 80% | 0.06% | 1.4% | M0 SP | 7.6 g/kg |
| BCP TECNO | | | | 20% | |
| SRT (212-1400 | | | | | |
| microns) | | | | | |
| NOCTO (125- | 100% | 0.06% | 1.4% | | 8.1 g/kg |
| 600 microns) | | | | | |

Although the description above contains certain specificities, they should not be interpreted as limitations to the scope of the invention, but as an example of a preferred embodiment of the same. Therefore, the scope of the present invention must not be determined by the embodiments illustrated, but by the attached set of claims and its legal equivalents.

We claim:

1. A carrier for delivering powder materials comprising:
a. a microbead; and
b. a coating provided on the microbead, the coating having an affinity for the powder material.

2. The carrier of claim 1 in which the microbead is a glass microbead.

3. The carrier of claim 1 in which the powder material is inorganic and the coating is a dipodal polysiloxane.

4. The carrier of claim 1 in which the powder material is an organic powder and the coating is vinyl polysiloxane.

5. The carrier of claim 1 in which the diameter of the microbead is in the range of 10 μm to 2360 μm.

6. The carrier of claim 5 in which the ratio of the weight of the coating to the weight of the microbead is in the range of 0.1 to 0.2% (w/w).

7. The carrier of claim 5 in which the ratio of the weight of the powder material to the weight of the microbead is in the range of 2 to 10% (w/w).

8. A powder-coated microbead comprising:
a. a microbead;
b. a coating provided on the microbead, the coating being one of a dipodal silane and vinyl polysiloxane, the coating having an affinity for the powder material; and
c. a powder material provided on said coating.

9. The powder-coated microbead of claim 8 in which the microbead is a glass microbead.

10. The powder-coated microbead of claim 8 in which the powder material is inorganic and the coating is a dipodal polysiloxane.

11. The powder-coated microbead of claim 8 in which the powder material is an organic powder and the coating is vinyl polysiloxane.

12. The powder-coated microbead of claim 8 in which the diameter of the microbead is in the range of 10 μm to 2360 μm.

13. The powder-coated microbead of claim 12 in which the ratio of the weight of the coating to the weight of the microbead is in the range of 0.1 to 0.2% (w/w).

14. The powder-coated microbead of claim 12 in which the ratio of the weight of the powder material to the weight of the microbead is in the range of 2 to 10% (w/w).

15. A method for delivering a powder material comprising:
a. providing a microbead;
b. providing a coating on the microbead, the coating having an affinity for the powder material; and
c. providing the powder material on the coating to form a powder-coated microbead;
in which the powder-coated microbead provides metered delivery of the powder material.

16. The method of claim 15 in which the microbead is a glass microbead.

17. The method of claim 15 in which the powder material is inorganic and the coating is a dipodal polysiloxane.

18. The method of claim 15 in which the powder material is an organic powder and the coating is vinyl polysiloxane.

19. The method of claim 15 in which the diameter of the microbead is in the range of 10 μm to 2360 μm.

20. The method of claim 19 in which the ratio of the weight of the coating to the weight of the microbead is in the range of 0.1 to 0.2% (w/w).

21. The method of claim 19 in which the ratio of the weight of the powder material to the weight of the microbead is in the range of 2 to 10% (w/w).
